(19) United States
(12) Patent Application Publication
(10) Pub. No.: US 2018/0121949 A1
(43) Pub. Date: May 3, 2018

(54) INCENTIVE METHOD, ONLINE TRANSACTION PLATFORM, AND INCENTIVE FUNDS PLATFORM FOR SAFE ONLINE TRANSACTIONS

(71) Applicants: ZHEJIANG GEELY HOLDING GROUP CO., LTD, Hangzhou (CN); ZHEJIANG GEELY AUTOMOBILE RESEARCH INSTITUTE CO., LTD, Taizhou (CN)

(72) Inventor: Shufu LI, Hangzhou (CN)

(21) Appl. No.: 15/563,882

(22) PCT Filed: Aug. 14, 2015
(86) PCT No.: PCT/CN2015/087068

§ 371 Date: Oct. 2, 2017

(30) Foreign Application Priority Data
Apr. 2, 2015 (CN) 201510154555.6

(51) Int. Cl. G06Q 30/02; G06Q 40/04

(52) U.S. Cl. CPC G06Q 30/0239; G06Q 20/382; G06Q 40/04; G06Q 30/0215

(57) ABSTRACT

An incentive method, network transaction platform and incentive fund platform for safe network transactions. The method comprises: when an incentive period is reached, a network transaction platform calculating a ratio of the sum of the service fees of all network transactions for each seller in the current incentive period to the sum of service fees of all network transactions for all sellers in the current incentive period, as an incentive fund distribution ratio for each seller in the current incentive period; the network transaction platform notifying an incentive fund platform of the incentive fund distribution ratio for each seller in the current incentive period; and the incentive fund platform transferring corresponding incentive fund into the seller's account according to the incentive fund distribution ratio for each seller, according to the total incentive fund in the current incentive period. By means of the present invention, stores can be urged, through an incentive mechanism, not to sell fake merchandise or to deceive consumers on the network transaction platform, avoiding transactional disputes between consumers and stores as far as possible.

The present application claims the priority of Chinese patent application No. 201510154555.6, entitled “Network transaction system and transaction platform server for network transaction platform”, filed on 2 Apr. 2015 to Patent Office of the People's Republic of China, which is incorporated here by reference with its entirety.

### FIELD OF THE INVENTION

The present application relates to the field of computer applications, and especially to an incentive method, network transaction platform and incentive fund platform for safe network transactions.

### BACKGROUND OF THE INVENTION

There are a variety of network transaction platforms at present, such as Taobao, Amazon, ebay, etc., and more and more consumers are keen on shopping through the network transaction platforms. Compared to solid shops, stores on network transaction platforms typically can provide more competitive commodity prices and more convenient shopping experiences. However, shopping on network transaction platforms obviously would be faced up to shopping risks such as fake merchandise or frauds, etc.

On some network transaction platforms, various stores are sale subjects (or referred to as sellers), and the network transaction platforms only provide a uniform platform for the various stores to conduct transactions with consumers (or referred to as buyers) and manage the normal operation of the platform. When a consumer has a transaction dispute with a store on the network transaction platform, in practice, the consumer usually can only initiate a rights protection action directly to the store.

However, it is well known that, in the network transaction platform, a store only has responsibility for its own profits and losses, and is not community of interests with the network transaction platform; that is to say, the achievement and reputation of the network transaction platform have little or even no relationship with the store. Due to having no access to sharing high return of the network transaction platform on the capital market, many stores seek nothing but profits, and glut the network transaction platform with low-quality and low-price products, attempting to pursuit profits with quantities, so that the network transaction platform is glutted with counterfeit and shoddy products, and the consumers are faced up with shopping risks such as fake merchandise or frauds when shopping on the network transaction platform, thus causing damage to the legitimate rights of the consumers. Moreover, because most stores in the network transaction platforms are small-scale stores, they have the features of living for a short time, having small compensation ability and the like. Therefore, generally, it is difficult for a consumer to protect rights with respect to a store. Furthermore, although the operator of a network transaction platform is generally a large-scale enterprise with abundant financial resources and is stable, since the network transaction platform is not a seller in a transaction, a consumer usually cannot initiate a rights protection action directly with respect to the network transaction platform.

### SUMMARY OF THE INVENTION

In order to solve the above-mentioned technical problems, the embodiments of the present invention provide an incentive method, network transaction platform and incentive fund platform for safe network transactions, so as to enable, by means of an incentive mechanism, stores to share high return of the network transaction platform in the capital market, and thus indirectly urge the stores not to deceive consumers with counterfeit and shoddy products on the network transaction platform, reducing the probability of consumers facing up to shopping risks such as fake merchandise or frauds when shopping on the network transaction platform, better guaranteeing the rights of the consumers.

According to a first aspect of the embodiments of the present invention, disclosed is an incentive method for a safe network transaction, comprising:

when an incentive period is reached, a network transaction platform calculating a ratio of the sum of the service fees of all network transactions, for each seller on the network transaction platform, in the current incentive period to the sum of the service fees of all network transactions, for all sellers on the network transaction platform, in the current incentive period, and taking the ratio as an incentive fund distribution ratio for each seller in the current incentive period;

the network transaction platform notifying an incentive fund platform of the incentive fund distribution ratio for each seller in the current incentive period;

the incentive fund platform calculating incentive fund for each seller in the current incentive period, according to total incentive fund in the current incentive period and the incentive fund distribution ratio for each seller in the current incentive period; and

the incentive fund platform transferring the incentive fund for each seller in the current incentive period into the seller's account.

According to .a second aspect of the embodiments of the present invention, disclosed is a network transaction platform. The network transaction platform comprises: a first processor;

wherein the first processor is configured to: when an incentive period is reached, calculate a ratio of the sum of the service fees of all network transactions, for each seller on the network transaction platform, in the current incentive period to the sum of the service fees of all network transactions, for all sellers on the network transaction platform, in the current incentive period, and take the ratio as an incentive fund distribution ratio for each seller in the current incentive period; and notify an incentive fund platform of the incentive fund distribution ratio for each seller in the current incentive period.

According to a third aspect of the embodiments of the present invention, disclosed is an incentive fund platform. The incentive fund platform comprises: a second processor;

wherein the second processor is configured to: when an incentive period is reached, calculate incentive fund for each seller in the current incentive period according to the total incentive fund in the current incentive period and the incentive fund distribution ratio for each seller in the current incentive period which is notified by a network transaction platform; and transfer the incentive fund for each seller in the current incentive period into the seller's account.

In the technical solutions of the present invention, the incentive fund platform is capable of providing incentive fund to sellers on the network transaction platform in each incentive period. On one hand, the incentive fund can enable the sellers to share high return of the network transaction platform in the capital market, and thus indirectly urge the sellers not to deceive consumers with counterfeit and shoddy products on the network transaction platform, reducing the probability of consumers facing up to shopping risks such as fake merchandise or frauds when shopping on the network transaction platform, better guaranteeing the rights of the consumers. On the other hand, the incentive fund distribution ratio is obtained by calculating according to a ratio of the sum of the service fees of all network transactions for the seller in an incentive period to the sum of the service fees of all network transactions for all sellers in an incentive period; that is to say, the more the service fee that the seller pays, the greater the incentive fund ratio, and the more the incentive fund finally obtained by the seller. Such a calculation mode of the incentive fund distribution ratio stimulates the seller to be more willing to pay the corresponding service fee for each network transaction. The service fees of various network transactions construct a compensation capital pool at the service fee platform; once an infringement behaviour happens, the service fee platform can provide a right defending channel and compensation to the buyer on the network transaction platform, and the buyer can also obtain compensation capital greater than or equal to the transactional capital from the service fee platform, without the need for claiming to the seller, thus facilitating improving the convenience and reliability for the buyer's right defending and compensation. At the same time, once a seller has been found selling counterfeit and shoddy products and leading to compensating for a consumer, the seller's chance to obtain the incentive fund will be reduced or even lost; on the other hand, the seller is also positively encouraged to sell formal qualified products, purifying the online shopping environment, improving the consumers' confidence in network transactions.

Moreover, the network transaction platform of the present invention differs from the means such as consumption insurance on other network transaction platforms in that: the means such as consumption insurance require the buyer to pay extra insurance expenses so that the shopping burden is increased for the buyer;

while the present invention does not require the buyer to pay extra insurance expenses and deducts a part of the service fee from the transactional capital of each network transaction as the source of compensation capital instead. In addition, the service fee platform in the present invention also differs from the own-running mode of other network transaction platforms in that: the network transaction platform in the own-running mode needs to take responsibility for breach of contract, but the difficulty for a buyer to defend his/her right against a large scale network transaction platform is great; while the service fee platform of the present invention can be managed by an operator different from that for the network transaction platform, and can provide guarantee for the buyer as a fair third party, wherein the processing procedure is fair, public, effective and timely.

Further, the present invention can realize the automation of electronic agreement signing to the greatest extent, and can conduct different processing flows for a newly set up store and an already established store. Additionally, when a network transaction platform signs an electronic agreement with a large amount of stores, according to the solution of the present invention, the time points of agreement signing can be distributed, protecting the network transaction platform from processing large amounts of data work in a short time period, reducing the instantaneous load for the transaction platform server, and reducing the total data processing amount for the network transaction platform as far as possible.

### BRIEF DESCRIPTION OF THE DRAWINGS

In order to describe the technical solutions in embodiments of the present invention or the prior art more clearly, the figures to be used in the embodiments will be simply introduced below. Apparently, the accompanying drawings in the following description show merely some embodiments of the present invention, and a person of ordinary skill in the art may still derive other drawings from these accompanying drawings without creative efforts.

FIG. 1 schematically shows an exemplary application scenario in which the implementation of the present invention can be embodied;

FIG. 2 shows a flow chart of an incentive method for a safe network transaction according to the embodiments of the present invention;

FIG. 3 shows a signalling map of a safe network transaction method according to the embodiments of the present invention;

FIG. 4 shows a signalling map of a network transaction platform according to the embodiments of the present invention signing an electronic agreement with a seller's client;

FIG. 5 shows a flow chart of a method for signing an electronic agreement according to the embodiments of the present invention;

FIG. 6 shows a structural block diagram of a network transaction platform according to the embodiments of the present invention;

FIG. 7 shows a structural block diagram of another network transaction platform according to the embodiments of the present invention;

FIG. 8 shows a structural block diagram of an incentive fund platform according to the embodiments of the present invention.

### DETAILED DESCRIPTION OF THE INVENTION

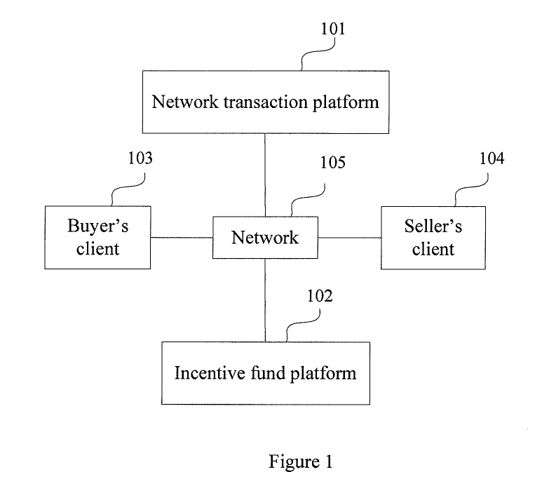

Please refer to FIG. 1, FIG. 1 schematically shows an exemplary application scenario in which the implementation of the present invention can be embodied. The scenario comprises a network transaction platform (or referred to as a network transaction server) 101, an incentive fund platform (or referred to as an incentive fund server) 102, a buyer's client 103 and a seller's client 104, which interact with each other through a network 105, so as to complete network transactions. The network transaction platform 101 and the incentive fund platform 102 can be mutually independent platforms and managed by different operators.

Method Embodiments

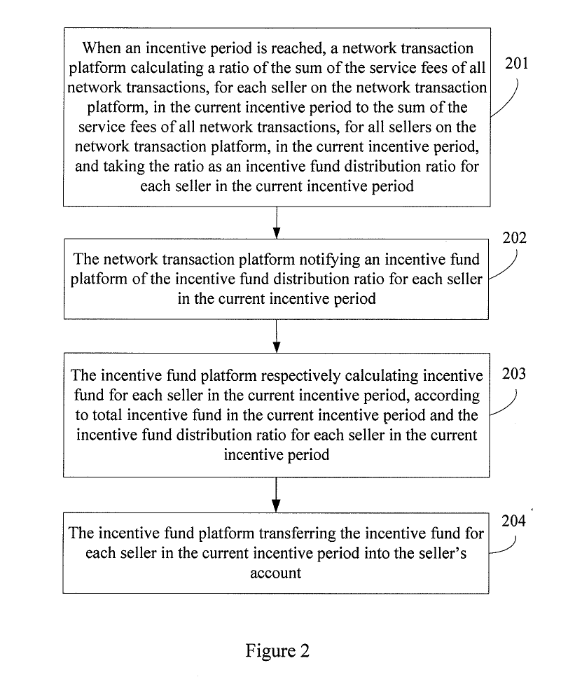

In conjunction with the application scenario shown in FIG. 1, please refer to FIG. 2, FIG. 2 shows a flow chart of an incentive method for a safe network transaction according to the embodiments of the present invention. The method, for example, can comprise the following steps:

S201: when an incentive period is reached, a network transaction platform calculating a ratio of the sum of the service fees of all network transactions, for each seller on the network transaction platform, in the current incentive period to the sum of the service fees of all network transactions, for all sellers on the network transaction platform, in the current incentive period, and taking the ratio as an incentive fund distribution ratio for each seller in the current incentive period;

S202: the network transaction platform notifying an incentive fund platform of the incentive fund distribution ratio for each seller in the current incentive period;

S203: the incentive fund platform respectively calculating incentive fund for each seller in the current incentive period, according to total incentive fund in the current incentive period and the incentive fund distribution ratio for each seller in the current incentive period; and

S204: the incentive fund platform transferring the incentive fund for each seller in the current incentive period into the seller's account.

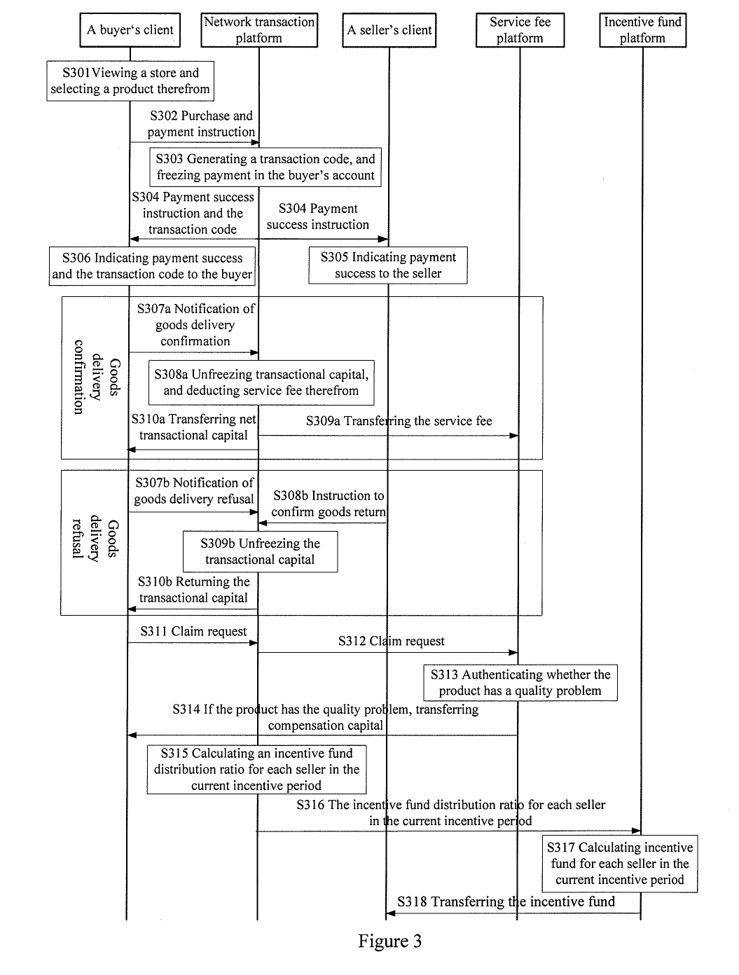

To describe the safe network transaction process of the present invention more comprehensively, please refer to FIG. 3, FIG. 3 shows a signalling map of a safe network transaction method according to the embodiments of the present invention. The method comprises:

S301: a buyer views a store on a network transaction platform via the buyer's client, and selects a product from the store;

S302: the buyer's client sends out a purchase and payment instruction for the product selected by the buyer to the network transaction platform;

S303: according to the purchase and payment instruction, the network transaction platform generates a transaction code for the network transaction and freezes payment pre-saved in the buyer's account (i.e. transactional capital of the network transaction);

S304: the network transaction platform sends out a payment success instruction to the buyer's client and the seller's client, and sends the transaction code for the network transaction to the buyer's client;

S305: according to the received payment success instruction, the seller's client indicates to the seller that the payment has succeeded, so that the seller arranges the delivery of the goods;

S306: according to the received payment success instruction, the buyer's client indicates to the buyer the payment success and the transaction code for the network transaction, so that the buyer tracks the goods delivery progress on the buyer's client at any time according to the transaction code, and waits for receiving of the goods;

S307a: if the buyer receives the goods and confirms the delivery of the goods, the buyer's client sends out a goods delivery confirmation notification to the network transaction platform;

S308a: the network transaction platform unfreezes the transactional capital of the network transaction, and deducts a part of fee from the transactional capital of the network transaction as a service fee of the network transaction;

S309a: the network transaction platform transfers the service fee of the network transaction to the service fee platform;

The service fee platform collects statistics about and records a service fee detail of each seller after receiving the service fee from the network transaction platform, and the service fee platform regularly feeds back the service fee detail to the corresponding seller's client. The service fees of the various network transactions construct a compensation capital pool at the service fee platform.

S310a: the network transaction platform transfers the transactional capital remained after deducting the service fee (or referred to as net transactional capital) to the seller's account, and the transaction procedure is ended;

S307b: if the buyer refuses to accept the goods after the goods has arrived due to various reasons, the buyer's client sends out a goods delivery refusal notification to the network transaction platform, and the buyer arranges the return of the goods;

S308b: after the seller receives the goods returned by the buyer, the seller's client sends to the network transaction platform an instruction to confirm the goods return;

S309b: the network transaction platform unfreezes the transactional capital of the network transaction;

S310b: the network transaction platform returns the transactional capital of the network transaction to the buyer's account, and the transaction procedure is ended;

S311: if the buyer finds out that the purchased product has a quality problem after using the product, the buyer's client sends out a claim request to the network transaction platform;

S312: the network transaction platform forwards the claim request to the service fee platform for processing;

Of course, the buyer's client can also send out the claim request directly to the service fee platform.

S313: the service fee platform authenticates whether the product has the quality problem;

S314: after confirming that the product has the quality problem, the service fee platform extracts a certain amount of compensation capital from the compensation capital pool and returns same to the buyer's account, and the compensation process is ended.

Of course, it should be noted that the amount of the compensation capital can be N times of the amount of the transactional capital of the network transaction, N being a positive integer.

S315: when an incentive period is reached, the network transaction platform calculates a ratio of the sum of the service fees of all network transactions, for each seller on the network transaction platform, in the current incentive period to the sum of the service fees of all network transactions, for all sellers on the network transaction platform, in the current incentive period, and takes the ratio as an incentive fund distribution ratio for each seller in the current incentive period;

S316: the network transaction platform notifies an incentive fund platform of the incentive fund distribution ratio for each seller in the current incentive period;

S317: the incentive fund platform calculates incentive fund for each seller in the current incentive period, according to total incentive fund in the current incentive period and the incentive fund distribution ratio for each seller in the current incentive period;

S318: the incentive fund platform transfers the incentive fund for each seller in the current incentive period into the seller's account, and the incentive process is ended.

It should be noted that the specific duration of the incentive period is not limited in the present invention, for example, the incentive period can be a year.

In an optional implementation of the present invention, the total incentive fund originates from the profit of the network transaction platform's capital in the trading market.

Alternatively, in another optional implementation of the present invention, the total incentive fund originates from the profit of the network transaction platform's capital in the financial market.

Additionally, in an optional implementation of the present invention, the network transaction platform, the incentive fund platform and the service fee platform are platforms which are mutually independent and are managed by different operators.

In the present invention, when a buyer and a buyer conduct a network transaction through the network transaction platform, an electronic agreement is signed between the network transaction platform and a client of the seller, wherein the electronic agreement comprises a convention about the incentive fund, for example, rules for appointing the incentive fund platform to pay incentive fund to stores and rules for calculating the incentive fund distribution ratio.

The signing of the electronic agreement can be started by the network transaction platform, and can be started by the seller's client.

When the signing of the electronic agreement is started by the network transaction platform, the signing of the electronic agreement between the network transaction platform and a client of the seller comprises: the network transaction platform detecting whether an electronic agreement has been signed between same and a set up store, if no electronic agreement is signed, generating an electronic agreement to be signed, and sending an electronic agreement signing request carrying the electronic agreement to be signed to the client of the seller to which the store belongs; and the seller's client sending to the network transaction platform an electronic agreement signing response indicating whether the seller accepts the electronic agreement.

The network transaction platform detecting whether an electronic agreement has been signed between same and a set up store comprises: in response to an order initiated by a buyer's client, the network transaction platform detecting whether an electronic agreement has been signed between same and a store corresponding to the order.

Agreement signing state information is stored on the network transaction platform, and the agreement signing state information has a signed state and an unsigned state, for indicating whether the network transaction platform has signed an electronic agreement with a set up store; and the network transaction platform detecting whether an electronic agreement has been signed between same and a set up store comprises: according to the agreement signing state information, the network transaction platform detecting whether an electronic agreement has been signed between same and the set up store.

The network transaction platform generates, in a page of the store presented to the buyer's client, an agreement signing state flag visible to the buyer corresponding to the agreement signing state information, wherein the agreement signing state flag is used for presenting to the buyer whether the store has signed the electronic agreement with the network transaction platform.

When the signing of the electronic agreement is started by the seller's client, the signing of the electronic agreement between the network transaction platform and a client of the seller comprises: the seller's client generating a store setting up request according to an input of the seller, and sending the store setting up request to the network transaction platform; the network transaction platform sending an electronic agreement signing request carrying the electronic agreement to be signed to the seller's client; and the seller's client sending to the network transaction platform an electronic agreement signing response indicating whether the seller accepts the electronic agreement.

When the electronic agreement signing response indicates that the seller accepts the electronic agreement, the network transaction platform sets the agreement signing state information about the store of the seller to be a signed state.

When the electronic agreement signing response indicates that the seller refuses the electronic agreement, the network transaction platform terminates the signing of the electronic agreement.

Before the network transaction platform generates the electronic agreement to be signed, the network transaction platform acquires store information about the store of the seller, and detects whether the store information is complete. When the store information is complete, the network transaction platform generates the electronic agreement to be signed.

When the store information is incomplete, the network transaction platform sends to the seller's client a form filling in request carrying an information collection form; the seller's client sends a form filling in response to the network transaction platform, wherein the form filling in response carries the information collection form in which the store information has been filled; and the network transaction platform extracts the store information from the information collection form and stores same on the network transaction platform.

When the store information is complete, the network transaction platform detects, according to the store information, whether the store satisfies an agreement signing requirement for signing an electronic agreement pre-determined by the network transaction platform. When the store satisfies the agreement signing requirement for signing the electronic agreement pre-determined by the network transaction platform, the network transaction platform generates the electronic agreement to be signed.

When the store does not satisfy the agreement signing requirement for signing the electronic agreement pre-determined by the network transaction platform, the network transaction platform terminates the signing of the electronic agreement.

At least one item in the store information is a risk relevant item related to store operation risks; and the network transaction platform detecting, according to the store information, whether the store satisfies an agreement signing requirement for signing the electronic agreement pre-determined by the network transaction platform comprises: the network transaction platform calculating a risk factor of the store by utilizing the risk relevant item according to a pre-determined algorithm, and comparing the risk factor of the store to a pre-set risk threshold; if the risk factor of the store is greater than or equal to the pre-set risk threshold, determining that the store does not satisfy the agreement signing requirement for signing the electronic agreement pre-determined by the network transaction platform; and if the risk factor of the store is smaller than the pre-set risk threshold, determining that the store satisfies the agreement signing requirement for signing the electronic agreement pre-determined by the network transaction platform.

A pre-set risk coefficient and weight corresponding to various risk relevant items are stored on the network transaction platform, and the risk factor is obtained by calculating according to the risk coefficient and weight of the risk relevant items in the store information.

When the network transaction platform terminates the signing of the electronic agreement, if the signing of the electronic agreement is started by the seller's client, the network transaction platform generates a store setting up response indicating the termination of the signing of the electronic agreement, and sends the store setting up response to the seller's client; and if the signing of the electronic agreement is started by the network transaction platform, the network transaction platform generates a transaction failure message indicating that the order is terminated due to that the electronic agreement cannot be signed, and sends the transaction failure message to the seller's client.

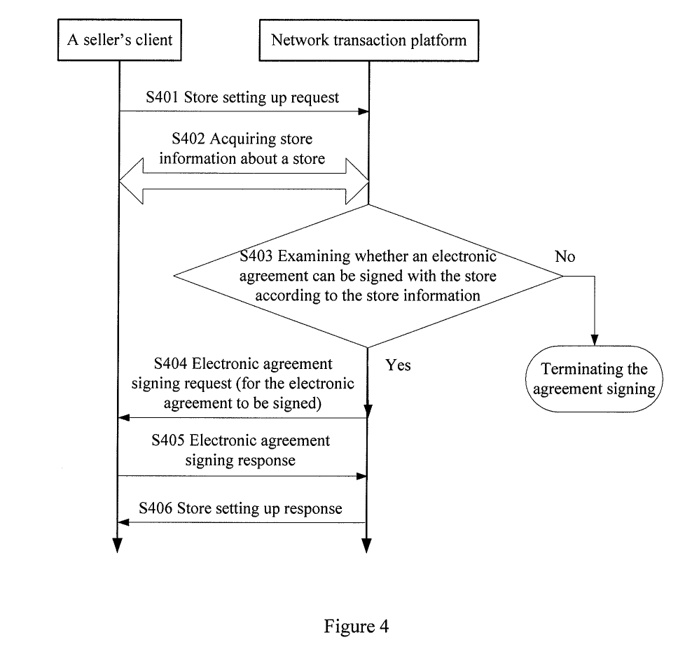

Please refer to FIG. 4, FIG. 4 shows a signalling map of a network transaction platform according to the embodiments of the present invention signing an electronic agreement with a seller's client. In the procedure or electronic agreement signing method shown in FIG. 4, the signing of the electronic agreement can be started by the network transaction platform or the seller's client; and FIG. 4 shows the procedure of signing an electronic agreement by taking the seller's client starting the signing of the electronic agreement as an example. The procedure particularly comprises:

S401: when the seller wants to newly set up a store in the network transaction platform, the seller's client generates a store setting up request according to an input from the seller and sends the store setting up request to the network transaction platform to start the signing of the electronic agreement.

In addition to the fact that the signing of the electronic agreement can be started by the seller's client, the network transaction platform can also actively detect whether the electronic agreement has been signed between the network transaction platform and an already established store, and in the case where the electronic agreement has not been signed, the network transaction platform generates an agreement signing instruction, so as to start the signing the of electronic agreement for the store.

It can be understood that, in other implementations, for a store which has already been set up in the network transaction platform, it is also possible for the seller's client to start the signing of the electronic agreement. In one implementation, the seller's client can generate an agreement signing request according to an input of the seller and send same to the network transaction platform, so as to start the signing of the electronic agreement, and this is similar to starting agreement signing for a newly set up store; therefore, in the present invention, the agreement signing request can be processed in a basically same way as that for a store setting up request.

In another implementation, the network transaction platform can monitor an order initiated by a buyer, and detect whether the electronic agreement has been signed between the network transaction platform and a store corresponding to the order in response to the monitored order. In this way, the detection of the electronic agreement for a certain store is triggered by an order related to the store. In other words, the network transaction platform detects whether the electronic agreement has been signed with the store only in the case where the store may have a transaction with a buyer. For some existing stores on the network transaction platform, although the electronic agreement is not signed, the signing of the electronic agreement can be not started by the network transaction platform as long as no transaction has occurred. As such, on one hand, the time points of the network transaction platform signing an agreement with a large amount of stores are distributed, avoiding the network transaction platform processing large amounts of data work related to agreement signing in a short time period, reducing the instantaneous load of the network transaction platform. On the other hand, for those stores which have no transaction later any more, the signing of the electronic agreement will not be started, thus useless data processing is avoided, reducing the total data processing amount of the network transaction platform.

Monitoring an order by the network transaction platform can be conducted after the order has been submitted by the buyer but before the order has been sent to the seller. After monitoring the order, the network transaction platform can suspend the processing procedure for the order and detect the electronic agreement. In the case where the network transaction platform has detected that the store corresponding to the order has not signed the electronic agreement, the network transaction platform can suspend the subsequent procedure of the order and generate a signing request for the electronic agreement, so as to start the signing of the electronic agreement for the store corresponding to the order. In the case where the network transaction platform has detected that the electronic agreement has been signed with the store corresponding to the order, the subsequent procedure of the order can be continued, for example, sending the order to the seller, so that the transaction between the buyer and the seller noimally proceeds.

In one implementation, the network transaction platform can store corresponding agreement signing state information for the various established stores, for indicating whether the network transaction platform has signed the desired electronic agreement with the store. The agreement signing state information can have a signed state and an unsigned state. It will be seen below that when the signing of the electronic agreement has been completed between the network transaction platform and the store, the agreement signing state information corresponding to the store can be set to the signed state. In this way, the network transaction platform can detect whether the electronic agreement has been signed according to the agreement signing state information about the store.

Typically, store information about various stores would be stored in the network transaction platform, and the agreement signing state information can be stored in the network transaction platform as a part of the store information.

S402: the network transaction platform acquires store information about the store.

For example, the required store information can comprise: the seller's name, the seller's address, the seller's registered capital, the seller's receipt account, categories of sold products, and other required certificates. This step can be carried out in the case where the network transaction platform does not have the store information about the store or in the case where the existing store information is incomplete. For example, for a store to be set up by the seller, the network transaction platform may have not stored any store information about the store. In some other circumstances, a part of the store information about the store is stored in the network transaction platform, but is incomplete for realizing various steps that will be described later. Of course, in the case where the network transaction platform has stored complete store information, especially for a set up store, the store information acquisition step can be omitted.

When the network transaction platform acquires the store information, the store information can be collected by utilizing an information collection form. The information collection form can be configured in advance by the network transaction platform according to the store information required thereby, and the completeness of the store information can be ensured in this way.

In one implementation, if the seller's client starts the agreement signing, the network transaction platform can return a form filling in request to the seller's client in response to the store setting up request from the seller's client, wherein the form filling in request carries the information collection form to be filled in. If the network transaction platform starts the agreement signing, the network transaction platform can send the form filling in request to the seller's client in response to an agreement signing instruction generated in the network transaction platform. In another implementation, an information collection form, which has not been filled in, can be pre-set in the seller's client; and when the network transaction platform acquires the store information, the network transaction platform can only send a form filling in request to the seller's client, wherein the form filling in request does not carry the information collection form to be filled in.

The seller's client can present in the seller's client the information collection form, which is from the network transaction platform or is pre-set, to the seller for same to fill in, in response to the form filling in request. After the seller has filled the store information in the information collection form by means of the seller's client, the seller's client sends the information collection form having filled with the store information to the network transaction platform. The network transaction platform extracts the store information from the information collection form, and stores the extracted store information in the network transaction platform. If the information collection form is pre-set in the seller's client, for convenience and improving the efficiency, the seller can send the information collection form together with the store setting up request to the network transaction platform after filling in the store information.

S403: the network transaction platform examines whether an agreement can be signed with the store according to the store information; if yes, step 404 is entered, otherwise, the agreement signing procedure is terminated.

In one implementation, the examination can comprise detecting whether the store information is complete for signing the electronic agreement. If the store information is incomplete, besides terminating the agreement signing procedure, it is also possible to return to the previously described step S402 again, to acquire the store information again. For example, the network transaction platform can send a form filling in request to the seller's client, so as to collect the store information through the information collection form.

Additionally, the examination can further comprise: detecting whether the store satisfies an agreement signing requirement for signing the electronic agreement pre-determined by the network transaction platform. In one implementation, the agreement signing requirement comprises risk assessment for the store. For example, one or more items in the store information acquired by the network transaction platform can be risk relevant items related to store operation risks; and the network transaction platform can calculate a risk factor of the store by utilizing the risk relevant item according to a pre-determined algorithm, and compares the risk factor of the store to a pre-determined risk threshold; if the risk factor of the store is greater than or equal to the risk threshold, the store does not satisfy the corresponding agreement signing requirement, otherwise, the store satisfies the corresponding agreement signing requirement.

To calculate the risk factor of the store, a pre-set risk coefficient and weight corresponding to various risk relevant items can be stored in the network transaction platform. In this way, the risk factor of the store can be obtained by calculating according to the risk coefficient and weight corresponding to the risk relevant items in the store information. Here, the risk relevant items are used for evaluating the operation risk of a store, and can, for example, comprise: the registered capital of the store, the operation time, the category of sold products, historical buyer comments, the claim history and amount, etc. In such a manner, the store can be examined automatically, so as to reduce manual workload. Of course, auxiliary manual examination can be added based on the automatic examination. Especially, with respect to the claim history and amount, they can be provided by the service fee platform to the network transaction platform.

When the store does not satisfy the agreement signing requirement, and the signing of the electronic agreement is started by the seller's client, for example, through a store setting up request, the network transaction platform can generate a store setting up refusal response and send same to the seller's client, so as to indicate to the seller that the currently conducted signing of the electronic agreement is terminated and it is refused to set up a store by the seller. When the store does not satisfy the agreement signing requirement, and the signing of the electronic agreement is started by the network transaction platform, for example, through an agreement signing instruction, since the order submitted by the buyer to the store is suspended right now, the network transaction platform can generate a transaction failure message and send same to the seller's client, so as to indicate to the seller that the order is terminated due to that the electronic agreement cannot be signed.

In the present invention, for a store which has signed the electronic agreement, a later examination can also be conducted on it, and the examination comprises detecting whether the store satisfies an elimination standard pre-determined by the network transaction platform. For example, a store would reach an elimination standard of the network transaction platform due to honesty problem when the store has a higher claim amount and more bad historical records; at this time, a revocation procedure for revoking the store from the network transaction platform can be started. In one implementation, the network transaction platform will send an instruction, indicating to terminate the present cooperative relationship, to the seller's client which has signed the electronic agreement, and publishes information about the eliminated seller on the network transaction platform, achieving the purpose of forbidding and putting an end to counterfeit and shoddy products on the platform, and informing the consumers of the seller information about the counterfeit and shoddy products.

S404: after the store passes the examination, the network transaction platform sends an electronic agreement signing request carrying the electronic agreement to be signed to the seller's client.

In one implementation, the network transaction platform can generate the electronic agreement to be signed by loading other information, such as the seller's name and the seller's address, on a pre-set agreement template. The pre-set agreement template can comprise corresponding rules for appointing the network transaction platform to pay incentive fund to stores and for calculating the incentive fund distribution ratio.

S405: the seller's client sends to the network transaction platform an electronic agreement signing response indicating whether the seller accepts the electronic agreement.

After reading the electronic agreement from the network transaction platform by means of the seller's client, the seller can input at the seller's client an instruction indicating whether the seller accepts the electronic agreement, and the seller's client produces an electronic agreement signing response according to the instruction and returns the electronic agreement signing response to the network transaction platform.

S406: the network transaction platform sends a store setting up response to the seller's client depending on whether the seller accepts the electronic agreement.

When the seller refuses to accept the electronic agreement, the network transaction platform terminates the agreement signing. In particular, when the seller refuses to accept the electronic agreement, and the signing of the electronic agreement is started by the seller's client, for example, through a store setting up request, the network transaction platform generates a store setting up refusal response and sends same to the seller's client, so as to indicate to the seller that the currently conducted signing of the electronic agreement is terminated and it is refused to set up a store by the seller. On the contrary, when the seller accepts the electronic agreement, and the signing of the electronic agreement is started by the seller's client, for example, through a store setting up request, the network transaction platform generates a store setting up permission response and sends same to the seller's client, so as to indicate to the seller that the currently conducted signing of the electronic agreement continues and the seller is allowed to set up a store.

When the seller refuses to accept the electronic agreement, and the signing of the electronic agreement is started by the network transaction platform, for example, through an agreement signing instruction, since the order submitted by the buyer to the store is suspended right now, the network transaction platform generates a transaction failure message and sends same to the seller's client, so as to indicate to the seller that the order is terminated due to that the electronic agreement cannot be signed. On the contrary, when the seller accepts the electronic agreement, and the signing of the electronic agreement is started by the network transaction platform, for example, through an agreement signing instruction, the network transaction platform generates a transaction success message and sends same to the seller's client, so as to indicate to the seller that the order is continued due to that the electronic agreement can be signed.

When the seller accepts the electronic agreement, and the signing of the electronic agreement is started by the seller's client, for example, through a store setting up request, the network transaction platform can also send information such as a store registration number and a store network address corresponding to the store to the seller's client, so as to indicate that the network transaction platform has formed a cooperative relationship with the seller, and that the seller can present and sell related products on the platform.

As previously described, whether the network transaction platform has signed the electronic agreement with the store can be indicated with agreement signing state information. In this way, after step 405, the network transaction platform can set the agreement signing state information about the corresponding store to a signed state or an unsigned state.

Additionally, the network transaction platform can also generate an agreement signing state flag visible to the buyer corresponding to the agreement signing state information in a store presentation page. In this way, the buyer identifies, by means of the agreement signing state flag on the store presentation page, whether the store is a store having signed the electronic agreement with the network transaction platform, so as to further determine the credit of the store.

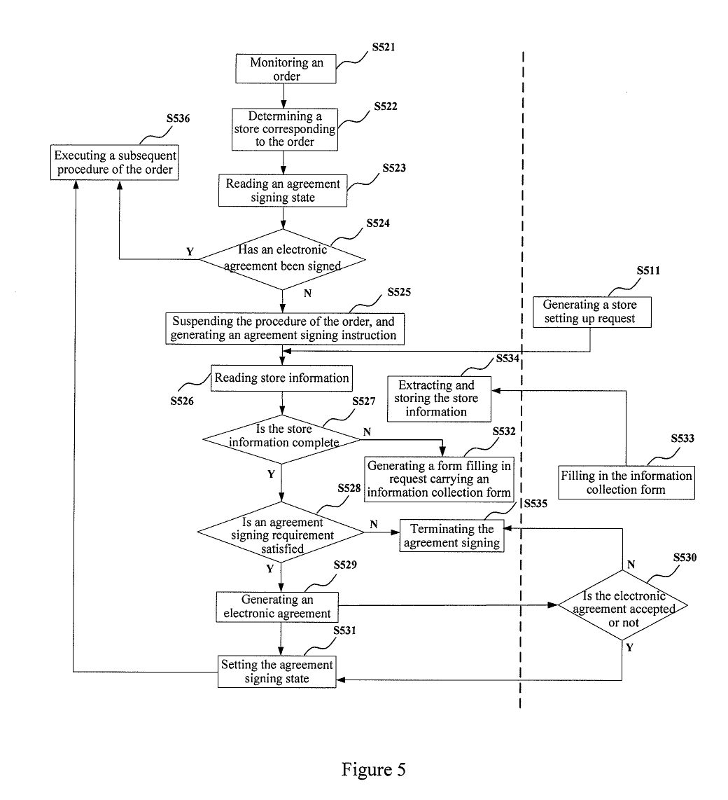

The method for signing an electronic agreement shown in FIG. 5 is a more particular implementation. In FIG. 5, a vertical dotted line is drawn, wherein the left side of the vertical line indicates actions executed by the network transaction platform, and the right side of the dotted line indicates actions executed by the seller's client.

As shown in FIG. 5, the procedure is started by the network transaction platform at S521 to S525. In S521 to S525, the network transaction platform actively detects whether the desired electronic agreement has been signed between the network transaction platform and the already established store, and when the electronic agreement has not been signed, the network transaction platform generates an agreement signing instruction, so as to start the signing of the electronic agreement for the store. The method particularly comprises:

S521: the network transaction platform monitors an order initiated by a buyer.

As previously described, the network transaction platform monitoring an order can be conducted after the order has been submitted by the buyer but before the order has been sent to the seller.

S522: in response to the monitored order, the network transaction platform determines a store corresponding to the order according to information about the order.

S523: the network transaction platform reads from the stored store information the agreement signing state information of the store corresponding to the order.

S524: the network transaction platform judges, according to the agreement signing state information, whether the electronic agreement has been signed with the store corresponding to the order; if yes, S537 is entered, otherwise, S525 is entered.

S525: the network transaction platform suspends the subsequent procedure of the order and generates the agreement signing instruction, so as to start the signing of the electronic agreement for the store corresponding to the order.

S526: the network transaction platform reads from the stored store information the store information about the store corresponding to the order, so as to conduct the subsequent detection process.

S527: the network transaction platform detects whether the store information is complete for signing the electronic agreement; if yes, S528 is entered, otherwise, S533 is entered.

S528: the network transaction platform detects whether the store corresponding to the order satisfies an agreement signing requirement for signing the electronic agreement pre-determined by the network transaction platform; if yes, S529 is entered, otherwise, S535 is entered.

S529: according to a pre-set agreement template, the network transaction platform generates the required electronic agreement and sends same to the seller's client.

The pre-set agreement template can comprise relevant rules for appointing the network transaction platform to pay incentive fund to stores and for calculating the incentive fund distribution ratio.

S530: the seller's client determines whether to accept the electronic agreement; if yes, S531 is entered, otherwise, S535 is entered.

S531: the network transaction platform sets the agreement signing state, and S536 is entered.

S532: the network transaction platform generates a form filling in request carrying an information collection form, and sends the form filling in request to the seller's client.

S533: the seller's client presents the information collection form to the seller for the seller to fill in, and returns the information collection form, in which the store information has been filled, to the network transaction platform.

S534: the network transaction platform extracts the store information from the information collection form and stores same, and the procedure is ended.

S535: the network transaction platform terminates the agreement signing procedure, and the procedure is ended.

S536: the network transaction platform executes a subsequent procedure of the order.

For example, in the subsequent procedure, the network transaction platform sends the order to the seller, so that the transaction between the buyer and the seller are conducted normally.

The procedure above can also be started by the seller's client at S511; that is to say, in S511, the seller wants to newly set up a store in the network transaction platform, the seller's client generates a store setting up request according to an input from the seller and sends same to the network transaction platform to start the signing of the electronic agreement, and S525 is entered.

In the technical solutions of the present invention, the incentive fund platform is capable of providing incentive fund to sellers on the network transaction platform in each incentive period. On one hand, the incentive fund can enable the sellers to share high return of the network transaction platform in the capital market, and thus indirectly urge the sellers not to deceive consumers with counterfeit and shoddy products on the network transaction platform, reducing the probability of consumers facing up to shopping risks such as fake merchandise or frauds when shopping on the network transaction platform, better guaranteeing the rights of the consumers. On the other hand, the incentive fund distribution ratio is obtained by calculating according to a ratio of the sum of the service fees of all network transactions for the seller in an incentive period to the sum of the service fees of all network transactions for all sellers in an incentive period; that is to say, the more the service fee that the seller pays, the greater the incentive fund ratio, and the more the incentive fund finally obtained by the seller. Such a calculation mode of the incentive fund distribution ratio stimulates the seller to be more willing to pay the corresponding service fee for each network transaction. The service fees of various network transactions construct a compensation capital pool at the service fee platform; once an infringement behaviour happens, the service fee platform can provide a right defending channel and compensation to the buyer on the network transaction platform, and the buyer can also obtain compensation capital greater than or equal to the transactional capital from the service fee platform, without the need for claiming to the seller, thus facilitating improving the convenience and reliability for the buyer's right defending and compensation. At the same time, once a seller has been found selling counterfeit and shoddy products and leading to compensating for a consumer, the seller's chance to obtain the incentive fund will be reduced or even lost; on the other hand, the seller is also positively encouraged to sell formal qualified products, purifying the online shopping environment, improving the consumers' confidence in network transactions.

Further, the present invention can realize the automation of electronic agreement signing to the greatest extent, and can conduct different processing flows for a newly set up store and an already established store. Additionally, when a network transaction platform signs an electronic agreement with a large amount of stores, according to the solution of the present invention, the time points of agreement signing can be distributed, protecting the network transaction platform from processing large amounts of data work in a short time period, reducing the instantaneous load for the transaction platform server, and reducing the total data processing amount for the network transaction platform as far as possible.

Apparatus Embodiments

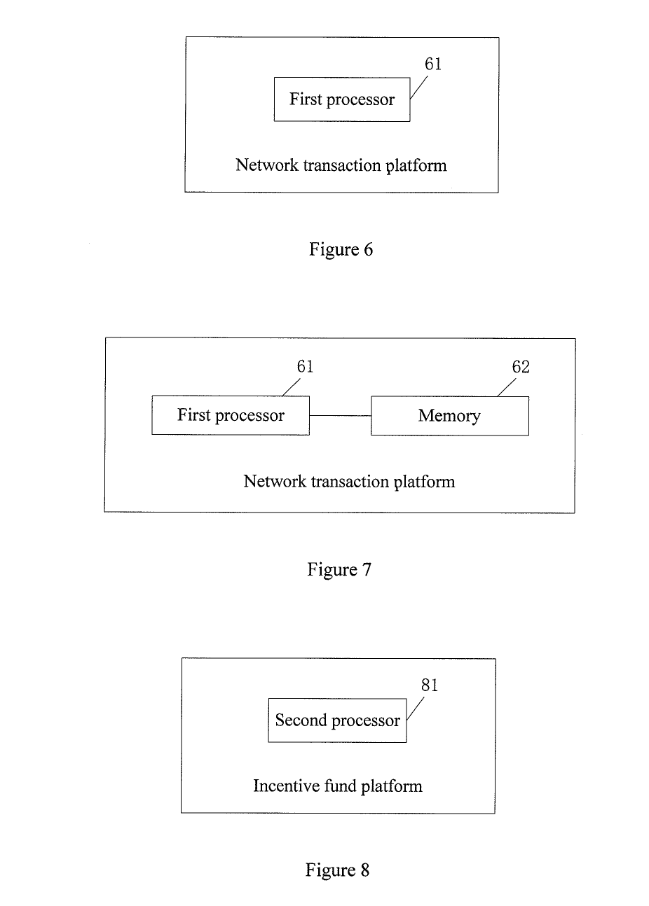

In addition to providing a safe network transaction method, the embodiments of the present invention also provide a network transaction platform. Please refer to FIG. 6, FIG. 6 shows a structural block diagram of a network transaction platform according to the embodiments of the present invention. The network transaction platform 60 comprises a first processor 61;

wherein the first processor 61 is configured to: when an incentive period is reached, calculate a ratio of the sum of the service fees of all network transactions, for each seller on the network transaction platform, in the current incentive period to the sum of the service fees of all network transactions, for all sellers on the network transaction platform, in the current incentive period, and take the ratio as an incentive fund distribution ratio for each seller in the current incentive period; and notify an incentive fund platform of the incentive fund distribution ratio for each seller in the current incentive period.

In an optional implementation of the present invention, the first processor 61 is further configured such that: when a buyer and a buyer conduct a network transaction through the network transaction platform, an electronic agreement is signed between the network transaction platform and a client of the seller, wherein the electronic agreement comprises a convention about the incentive fund.

In another optional implementation of the present invention, the signing of the electronic agreement is started by the network transaction platform or the seller's client.

In another optional implementation of the present invention, when the signing of the electronic agreement is started by the network transaction platform, the first processor 61 is particularly. configured to: detect whether the network transaction platform has signed an electronic agreement with a set up store, if no electronic agreement is signed, generate an electronic agreement to be signed, and send an electronic agreement signing request carrying the electronic agreement to be signed to the client of the seller to which the store belongs; and receive an electronic agreement signing response, indicating whether the seller accepts the electronic agreement, sent by the seller's client.

In another optional implementation of the present invention, when the signing of the electronic agreement is started by the network transaction platform, the first processor 61 is particularly configured to: in response to an order initiated by a buyer's client, detect whether the network transaction platform has signed an electronic agreement with a set up store, if no electronic agreement is signed, generate an electronic agreement to be signed, and send an electronic agreement signing request carrying the electronic agreement to be signed to the client of the seller to which the store belongs; and receive an electronic agreement signing response, indicating whether the seller accepts the electronic agreement, sent by the seller's client.

In another optional implementation of the present invention, as shown in FIG. 7, the network transaction platform 60 further comprises a memory 62, wherein the memory 62 is configured to: store agreement signing state information, wherein the agreement signing state information has a signed state and an unsigned state, for indicating whether the network transaction platform has signed an electronic agreement with a set up store; and

the first processor 61 is particularly configured to: according to the agreement signing state information, detect whether the electronic agreement has been signed between the network transaction platform and a set up store.

In another optional implementation of the present invention, the first processor 61 is further configured to: generate, in a page of the store presented to the buyer's client, an agreement signing state flag visible to the buyer corresponding to the agreement signing state information, wherein the agreement signing state flag is used for presenting to the buyer whether the store has signed the electronic agreement with the network transaction platform.

In another optional implementation of the present invention, when the signing of the electronic agreement is started by the seller's client, the first processor 61 is particularly configured to: in response to a store setting up request sent by the seller's client, send to the seller's client an electronic agreement signing request carrying the electronic agreement to be signed; and receive an electronic agreement signing response sent by the seller's client indicating whether the seller accepts the electronic agreement.

In another optional implementation of the present invention, the first processor 61 is further configured to: when the electronic agreement signing response indicates that the seller accepts the electronic agreement, set the agreement signing state information about the store of the seller to be a signed state.

In another optional implementation of the present invention, the first processor 61 is further configured such that: when the electronic agreement signing response indicates that the seller refuses the electronic agreement, the network transaction platform terminates the signing of the electronic agreement.

In another optional implementation of the present invention, the first processor 61 is further configured to: before generating the electronic agreement to be signed, acquire the store information about the store of the seller and detect whether the store information is complete; and when the store information is complete, generate the electronic agreement to be signed.

In another optional implementation of the present invention, the first processor 61 is further configured to: when the store information is incomplete, send to the seller's client a form filling in request carrying an information collection form; receive a form filling in response sent by the seller's client, the form filling in response carrying the information collection form in which the store information has been filled; and extract the store information from the information collection form and store same on the network transaction platform.

In another optional implementation of the present invention, the first processor 61 is further configured to: when the store information is complete, detect, according to the store information, whether the store satisfies an agreement signing requirement for signing an electronic agreement pre-determined by the network transaction platform; and when the store satisfies the agreement signing requirement for signing the electronic agreement pre-determined by the network transaction platform, generate the electronic agreement to be signed.

In another optional implementation of the present invention, the first processor 61 is further configured to: when the store does not satisfy the agreement signing requirement for signing the electronic agreement pre-determined by the network transaction platform, terminate the signing of the electronic agreement.

In another optional implementation of the present invention, at least one item in the store information is a risk relevant item related to store operation risks; and

the first processor 61 is particularly configured to: calculate a risk factor of the store by utilizing the risk relevant item according to a pre-determined algorithm, and compare the risk factor of the store to a pre-set risk threshold; if the risk factor of the store is greater than or equal to the pre-set risk threshold, determine that the store does not satisfy the agreement signing requirement for signing the electronic agreement pre-determined by the network transaction platform; and if the risk factor of the store is smaller than the pre-set risk threshold, determine that the store satisfies the agreement signing requirement for signing the electronic agreement pre-determined by the network transaction platform.

In another optional implementation of the present invention, the memory 62 is further configured to: store a pre-set risk coefficient and weight corresponding to various risk relevant items, and the risk factor is obtained by calculating according to the risk coefficient and weight of the risk relevant items in the store information.

In another optional implementation of the present invention, the first processor 61 is further configured to: when terminating the signing of the electronic agreement, if the signing of the electronic agreement is started by the seller's client, generate a store setting up response indicating the termination of the current signing of the electronic agreement, and send the store setting up response to the seller's client; and if the signing of the electronic agreement is started by the network transaction platform, generate a transaction failure message indicating that the order is terminated due to that the electronic agreement cannot be signed, and send the transaction failure message to the seller's client.

In addition to providing a safe network transaction method, the embodiments of the present invention also provide a network transaction platform. Please refer to FIG. 8, FIG. 8 shows a structural block diagram of a service fee platform according to the embodiments of the present invention. The service fee platform 80 comprises a second processor 81;

wherein the second processor 81 is configured to: when an incentive period is reached, calculate incentive fund for each seller in the current incentive period according to the total incentive fund in the current incentive period and the incentive fund distribution ratio for each seller in the current incentive period which is notified by a network transaction platform; and transfer the incentive fund for each seller in the current incentive period into the seller's account.

In the technical solutions of the present invention, the incentive fund platform is capable of providing incentive fund to sellers on the network transaction platform in each incentive period. On one hand, the incentive fund can enable the sellers to share high return of the network transaction platform in the capital market, and thus indirectly urge the sellers not to deceive consumers with counterfeit and shoddy products on the network transaction platform, reducing the probability of consumers facing up to shopping risks such as fake merchandise or frauds when shopping on the network transaction platform, better guaranteeing the rights of the consumers. On the other hand, the incentive fund distribution ratio is obtained by calculating according to a ratio of the sum of the service fees of all network transactions for the seller in an incentive period to the sum of the service fees of all network transactions for all sellers in an incentive period; that is to say, the more the service fee that the seller pays, the greater the incentive fund ratio, and the more the incentive fund finally obtained by the seller. Such a calculation mode of the incentive fund distribution ratio stimulates the seller to be more willing to pay the corresponding service fee for each network transaction. The service fees of various network transactions construct a compensation capital pool at the service fee platform; once an infringement behaviour happens, the service fee platform can provide a right defending channel and compensation to the buyer on the network transaction platform, and the buyer can also obtain compensation capital greater than or equal to the transactional capital from the service fee platform, without the need for claiming to the seller, thus facilitating improving the convenience and reliability for the buyer's right defending and compensation. At the same time, once a seller has been found selling counterfeit and shoddy products and leading to compensating for a consumer, the seller's chance to obtain the incentive fund will be reduced or even lost; on the other hand, the seller is also positively encouraged to sell formal qualified products, purifying the online shopping environment, improving the consumers' confidence in network transactions.

Further, the present invention can realize the automation of electronic agreement signing to the greatest extent, and can conduct different processing flows for a newly set up store and an already established store. Additionally, when a network transaction platform signs an electronic agreement with a large amount of stores, according to the solution of the present invention, the time points of agreement signing can be distributed, protecting the network transaction platform from processing large amounts of data work in a short time period, reducing the instantaneous load for the transaction platform server, and reducing the total data processing amount for the network transaction platform as far as possible.

It should be noted that a person of ordinary skill in the art could understand that the entire procedure for implementing the above-mentioned embodiment methods or a part of the procedure can be completed by a computer program instructing related hardware; the program can be stored in a computer readable storage medium; and when executed, the program can comprise the procedure of the various method embodiments stated above. The storage medium can be diskettes, optical disks, Read-only memory (ROM) or random access memory (RAM), etc.

Detailed instruction is made to the incentive method, network transaction platform and incentive fund platform for safe network transactions provided in the present invention; particular embodiments are applied to describe the principle and implementations of the present invention; and the above description of the embodiments is only used for assisting in understanding the method of the present invention and core ideas thereof. At the same time, for a person of ordinary skill in the art, according to the thoughts of the present invention, modifications will be made to both particular implementations and the application scope. In summary, the contents of the specification should not be construed as limitations to the present invention.

1. An incentive method for a safe network transaction, characterized by comprising:
when an incentive period is reached, a network transaction platform calculating a ratio of the sum of the service fees of all network transactions, for each seller on the network transaction platform, in the current incentive period to the sum of the service fees of all network transactions, for all sellers on the network transaction platform, in the current incentive period, and taking the ratio as an incentive fund distribution ratio for each seller in the current incentive period;
the network transaction platform notifying an incentive fund platform of the incentive fund distribution ratio for each seller in the current incentive period;
the incentive fund platform calculating incentive fund for each seller in the current incentive period, according to total incentive fund in the current incentive period and the incentive fund distribution ratio for each seller in the current incentive period; and
the incentive fund platform transferring the incentive fund for each seller in the current incentive period into the seller's account.

2. The method according to claim 1, characterized in that the service fee of any network transaction conducted on the network transaction platform is deducted from the transactional capital of the network transaction and is transferred to a service fee platform by the network transaction platform when a buyer and a seller conduct the network transaction.

3. The method according to claim 2, characterized in that the service fees of various network transactions conducted on the network transaction platform construct a compensation capital pool on the service fee platform, and when the buyer initiates a claim for any network transaction, a part of capital in the compensation capital pool is transferred to the buyer's account by the service fee platform as compensation capital for the network transaction.

4. The method according to claim 1, characterized in that the total incentive fund originates from the profit of the network transaction platform's capital in the trading market.

5. The method according to claim 1, characterized in that the total incentive fund originates from the profit of the network transaction platform's capital in the financial market.

6. The method according to claim 1, characterized in that the network transaction platform and the incentive fund platform are platforms which are mutually independent and are managed by different operators.

7. The method according to claim 2, characterized in that the network transaction platform, the service fee platform and the incentive fund platform are platforms which are mutually independent and are managed by different operators.

8. The method according to claim 1, characterized in that the method further comprises:
when a buyer and a buyer conduct a network transaction through the network transaction platform, an electronic agreement is signed between the network transaction platform and a client of the seller, wherein the electronic agreement comprises a convention about the incentive fund.

9. A network transaction platform, characterized in that the network transaction platform comprises a first processor;
the first processor is configured to: when an incentive period is reached, calculate a ratio of the sum of the service fees of all network transactions, for each seller on the network transaction platform, in the current incentive period to the sum of service fees of all network transactions, for all sellers on the network transaction platform, in the current incentive period, and take the ratio as an incentive fund distribution ratio for each seller in the current incentive period; and notify an incentive fund platform of the incentive fund distribution ratio for each seller in the current incentive period.

10. An incentive fund platform, characterized in that the incentive fund platform comprises a second processor;
the second processor is configured to: when an incentive period is reached, calculate incentive fund for each seller in the current incentive period according to the total incentive fund in the current incentive period and the incentive fund distribution ratio for each seller in the current incentive period which is notified by a network transaction platform; and transfer the incentive fund for each seller in the current incentive period into the seller's account.
